(19) United States
(12) Patent Application Publication
(10) Pub. No.: US 2025/0147790 A1
(43) Pub. Date: May 8, 2025

(54) Methods, Systems and Computer Program Products for Optimized Virtualization of Processing Units for Cloud Computing Based Services

(71) Applicant: Now.gg, Inc., Campbell, CA (US)

(72) Inventor: Rosen Sharma, Monte Sereno, CA (US)

(21) Appl. No.: 18/938,075

(22) Filed: Nov. 5, 2024

Related U.S. Application Data
(60) Provisional application No. 63/547,451, filed on Nov. 6, 2023.

(51) Int. Cl. G06F 9/455

(52) U.S. Cl. CPC G06F 9/45558

(57) ABSTRACT

The invention relates to on-demand cloud computing. In particular, the present invention provides methods, systems and computer program products for optimized virtualization of processing units for implementing cloud computing based services. In an embodiment, the invention includes (i) receiving a request for instantiating at least one cloud computing service, (ii) assigning for execution of the at least one cloud computing service a first set of central processing unit (CPU) shares, and a first set of graphic processing unit (GPU) shares, and (iii) executing a set of processes corresponding to the at least one cloud computing service using the first set of CPU shares and the first set of GPU shares, wherein the GPU shares and the CPU shares have been asymmetrically generated.

### CROSS-REFERENCE TO RELATED APPLICATION

This application claims priority to U.S. Provisional Patent Application No. 63/547,451 filed Nov. 6, 2023, the disclosure of which is hereby incorporated by reference in its entirety.

### BACKGROUND OF THE INVENTION

### Field of the Invention

The present invention relates to cloud service computing. In particular, the present invention provides methods, systems and computer program products for optimized virtualization of processing units for implementing cloud computing based services.

### Description of Related Art

Development of cloud-based computing platforms has enabled fast, convenient and scalable deployment of web-based software services and solutions without the need for investment by a user in a permanent or dedicated hardware resource pool. Cloud computing platforms are configured to deploy a set of hosted resources such as computing devices or systems processors, operating systems, software and other components that can be combined together to form virtual machines. A user of an on-demand cloud computing platform can request instantiation of one or more virtual machines from the hosted resources, via a cloud computing platform management system, and can utilize the instantiated virtual machine(s) to perform one or more tasks or applications. For example, a user of an on-demand cloud computing platform may wish to set up and instantiate a virtual server from the cloud to create a platform for online gaming where computer games are executed on hosted data processing resources, and video and audio output from the hosted computer games is streamed to one or more remote terminals through which gamers are accessing or playing the hosted computer games. The user of the on-demand cloud computing platform can accordingly lease or subscribe to the set of resources needed to build and run the set of instantiated virtual machines on a long term-basis (e.g. weeks or months), or on a short-term basis (e.g. hours or days or minutes), for executing a desired software application(s).

Various providers offer on-demand cloud computing platforms including, for example, Amazon's “EC2”, Microsoft Azure, and Rackspace Cloud. Resources from these providers can be made available as on-demand resources, and the pricing for securing on-demand resources can vary significantly depending on the parameters of the on-demand resource request and the scarcity of available resources at the time the request is made.

In particular, it has been found that there is a significant different in pricing for availing central processing units (CPUs) from a cloud computing platform and graphic processing units (GPUs) from a cloud computing platform. All other parameters being the same, the price for reserving or using processing resources of a GPU from a cloud computing platform is significantly higher than the price for reserving or using processing resources of a CPU from a cloud computing platform.

Additionally, given that CPUs and GPUs have different processing capabilities, conventional solutions for implementing virtual machines through a combinations of one or more CPUs and GPUs fail to utilize the processing capabilities of the allocated CPUs and GPUs optimally, resulting in inefficient usage of processing capabilities of the allocated CPUs and GPUs.

There is accordingly a need for solutions for optimized virtualization of processing units that have been availed from a cloud computing platform for implementing cloud computing based services.

### SUMMARY OF THE INVENTION

The invention relates to cloud computing services. In particular, the present invention provides methods, systems and computer program products for optimized virtualization of processing units for implementing cloud computing based services.

The invention provides a method for optimized virtualization of processing units for implementing one or more cloud computing services. In an embodiment, the method comprises implementing at a processor, the steps of (i) receiving a request for instantiating at least one cloud computing service, (ii) assigning for execution of the at least one cloud computing service (a) a first set of central processing unit (CPU) shares, and (b) a first set of graphic processing unit (GPU) shares, and (iii) executing a set of processes corresponding to the at least one cloud computing service, wherein (c) a first sub-set of processes within the set of processes are executed by the first set of CPU shares, and (d) a second sub-set of processes within the set of processes are executed by the first set of GPU shares.

The invention also provides a system for optimized virtualization of processing units for implementing one or more cloud computing services. In an embodiment, the system comprises at least one memory, and a processor. The processor is configured to perform the steps of (i) receiving a request for instantiating at least one cloud computing service, (ii) assigning for execution of the at least one cloud computing service (a) a first set of central processing unit (CPU) shares, and (b) a first set of graphic processing unit (GPU) shares, and (iii) executing a set of processes corresponding to the at least one cloud computing service, wherein (c) a first sub-set of processes within the set of processes are executed by the first set of CPU shares, and (d) a second sub-set of processes within the set of processes are executed by the first set of GPU shares.

The invention also provides a computer program product for optimized virtualization of processing units for implementing one or more cloud computing services. In an embodiment, the computer program product comprises a non-transitory computer readable medium having a computer readable program code embodied therein, the computer readable program code comprising instructions for implementing the steps of (i) receiving a request for instantiating at least one cloud computing service, (ii) assigning for execution of the at least one cloud computing service (a) a first set of central processing unit (CPU) shares, and (b) a first set of graphic processing unit (GPU) shares, and (iii) executing a set of processes corresponding to the at least one cloud computing service, wherein (c) a first sub-set of processes within the set of processes are executed by the first set of CPU shares, and (d) a second sub-set of processes within the set of processes are executed by the first set of GPU shares.

### BRIEF DESCRIPTION OF THE DRAWINGS

FIG. 1 illustrates a system environment for providing cloud computing services.

FIG. 2 illustrates an exemplary cloud computing environment, in which cloud computing resources can be requested and utilized by resource users.

FIG. 3 illustrates a system environment in which a cloud services platform implements virtual machines or software instances for provision of cloud computing services, on computing resources from within a cloud computing platform.

FIG. 4 illustrates a system environment configured to enable optimized virtualization of processing units for implementing cloud computing based services

FIG. 5 is a flowchart illustrating a method for optimized virtualization of processing units for implementing cloud computing based services.

FIG. 6 illustrates an exemplary system for implementing the present invention.

### DESCRIPTION OF THE INVENTION

The invention relates to cloud computing services. In particular, the present invention provides methods, systems and computer program products for optimized virtualization of processing units for implementing cloud computing based services.

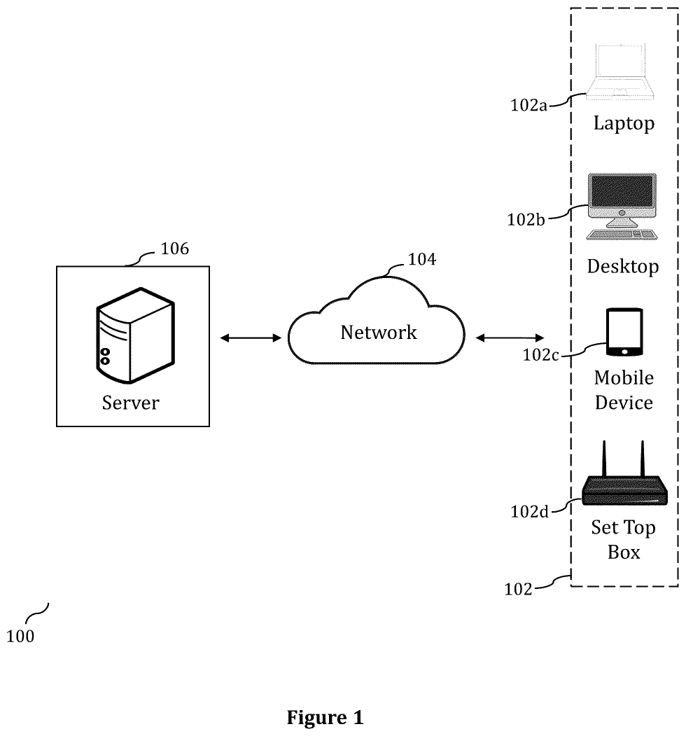

In an embodiment, the invention may be implemented within a system environment 100 of a kind illustrated in FIG. 1.

System environment 100 comprises one or more client devices 102 (for example, any of laptop 102a, desktop 102b, mobile device 102c and/or set top box 102d) interfacing through network 104, with a server 106. The server 106 may be configured to support a conventional server-client arrangement, where the client device 102 may communicate with server 106 for any one or more of several purposes, including for example downloading a software application, configuring the downloaded software application, updating the downloaded software application, or enabling client device 102 to upload or download data.

Alternatively, server 106 may be configured to provide cloud based service(s) to a requesting client device 102, wherein a software application required by client device 102 is installed and run on server 106, and video and audio output data from the software application is streamed to and rendered on client device 102. The inputs received from a user or operator of the client device 102 are in turn transmitted back to server 106 and are used to control execution of the software application that is running on the server 106.

So for example, in a cloud based gaming environment, a game software is installed and run on a hardware device configured to run the game software—and which is integrated or coupled with server 106. The game software is run on the hardware device and video and audio gameplay data is streamed from the hardware device (optionally through server 106) to a client device 102, where it is rendered for display and/or audio playback. A gameplayer who is operating client device 102 uses the interface controls of client device 102 to provide gameplay inputs—which are streamed back to the hardware device on which the game software is being executed and is used as gameplay control inputs for the game software that is being run on said hardware device.

The embodiments described generally in connection with FIG. 1 in can be implemented in or supported by a cloud network architecture. For the purposes of the present invention, a “cloud” can comprise a collection of resources that can be invoked to instantiate a virtual machine, process, or other resource for a defined duration or a limited duration.

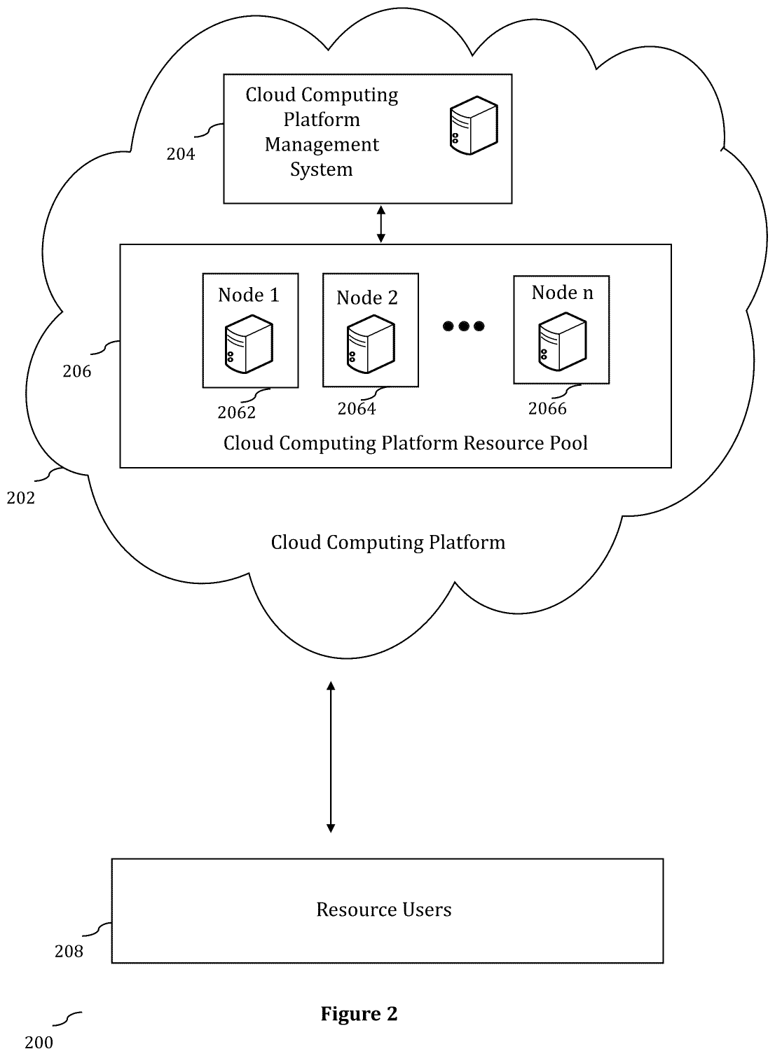

FIG. 2 illustrates an exemplary cloud computing environment 200, in which cloud computing resources can be requested and utilized by resource users. As shown for example in FIG. 2, cloud computing environment 200 comprises cloud computing platform 202, and resource users 208. It would be understood that in certain embodiments of the invention, a resource user 208 may comprise a server 106 of a type that is being used to provide cloud services in the manner that has been described above in connection with FIG. 1.

Cloud computing platform 202 comprises cloud computing management system 204 and cloud computing platform resource pool 206. Cloud computing platform resource pool 206 comprises a set of nodes—the set of nodes comprising nodes 1 to n (2062, 2064,2066)—wherein each node includes at least a processor, or a computing device, or a server, or a set of integrated circuit based computing components, and is configured to deliver or make available said processor, computing device, server, or one or more integrated circuit based computing components, for instantiating or operating a virtual machine process or other resource that is required for implementing a cloud computing service for a user (e.g. a resource user) of cloud computing platform 202. By way of example, (i) a set of one or more nodes can host and serve an operating system (or parts of an operating system) to instantiate and deliver a virtual machine, (ii) a set of one or more nodes (i.e. the same or a different set) can accept requests to host computing cycles or processor time, to supply a required capability of processing functionality to a virtual machine, (iii) a set of one or more nodes (i.e. the same or a different set) can host and serve applications to load on an instantiation of a virtual machine. In an embodiment, the pool of nodes 1 to n (2062, 2064, 2066) may comprise one or more CPUs and one or more GPUs—wherein said one or more CPUs and one or more GPUs are configured such that they are capable of being assigned to a requesting resource user from among resource users 208.

In certain embodiments, the set of nodes 206 as well as other hardware or software resources that are used to implement or operate cloud computing platform 202 and/or instantiated virtual machines within cloud computing platform 202 are managed by cloud computing platform management system 204. Cloud computing platform management system 204 can comprise a processor based computing device or a server, and/or other software, hardware, and network tools that are configured to communicate via one or more networks such as the Internet or other public or private networks with one or more or all of nodes 2062 to 2066, for managing and controlling cloud computing platform 202 and its operation.

In an embodiment, cloud computing platform management system 204 may be configured such that, for instantiating a new virtual machine, or for initiating a cloud computing session, using one or more nodes 2062 to 2066 within cloud computing platform 202, a resource user (for example, a resource user from within the set of resource users 208) can transmit a virtual machine instantiation request or a cloud computing session request to cloud computing platform management system 204. In specific embodiments, the request may specify information regarding the particular type of virtual machine or cloud session that is requested and/or the required functionality or end-use application. Cloud computing platform management system 204 receives the request, and processes the request by identifying the type of virtual machine, process, session or other resource being requested. Cloud computing platform management system 204 is configured to identify the collection of nodes necessary to instantiate that machine, session or resource.

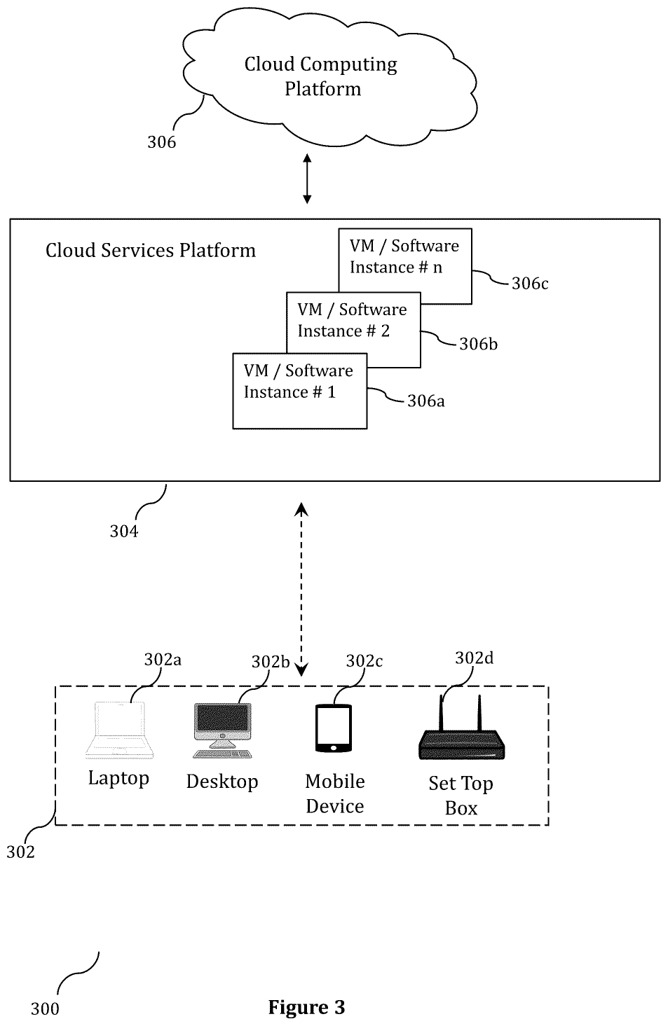

FIG. 3 illustrates a system environment 300 in which a cloud services platform 304 implements virtual machines or software instances for provision of cloud services—wherein said virtual machines or software instances are implemented on computing resources requested and obtained from within a cloud computing platform 306.

System environment 300 comprises one or more client devices 302 (for example, any of laptop 302a, desktop 302b, mobile device 302c and/or set top box 302d) interfacing through a communication network such as a data network or the internet (not shown), with a cloud services platform 304. In an embodiment, the cloud services platform 304 may comprise a server system comprising one or more computing devices or servers or processing units. The cloud services platform 304 may be configured to use a plurality of discrete or distinct hardware systems—each of which is configured to be provisioned with, and to instantiate and run a discrete instance of one or more software applications. In an embodiment, the cloud services platform 304 may comprise at least a cloud services server. The cloud services platform 304 may utilize a plurality of discrete or distinct hardware systems to simultaneously run a first virtual machine or a software instance #1 (306a), a second virtual machine or a software instance #2 (306b), upto an nth virtual machine or software instance #n (306c)—such that video and/or audio data or any other output data from each of these virtual machines or software instances 306a to 306c may be transmitted or streamed to one or more requesting client devices 302a to 302d.

As shown in FIG. 3, in particular embodiments, cloud services platform 304 may access and utilize processing resources or nodes within cloud computing platform 306 for generating and operating the virtual machines and/or software instances necessary to provide cloud services to the one or more requesting client devices 302a to 302d. In such embodiments, it would be understood that cloud services platform 304 would secure access to and utilize processing resources or nodes within cloud computing platform 306, in the manner of a resource user 208 accessing cloud computing resources or nodes within cloud computing platform 202 as described above in connection with FIG. 2.

In an embodiment, the processing resources or nodes within cloud computing platform 306 that are accessed and utilized by cloud services platform 304 for the purposes of generating and operating virtual machines and/or software instances, may comprise one or more CPUs and one or more GPUs.

When a given pool of CPUs and GPUs are available to cloud services platform 306 for implementation of one or more virtual machines, or one or more software instances, for the purposes of delivering cloud services to client terminals, the following approaches to virtualization of such CPUs and GPUs are possible:
a first approach involves assigning one or more CPUs and/or one or more GPUs exclusively to a single virtual machine or a single software instance, for implementing said virtual machine or software instance.
a second approach involves securing or reserving (either within the cloud services platform itself, or from within a cloud computing platform with which the cloud services platform is communicably coupled) a set of CPUs and GPUs for implementing an identified number (i.e. defined number or finite number) of virtual machines or software instances, and sharing the computing resources of the CPUs and GPUs within that set, among the identified number of virtual machines or software instances. In this approach, the resources of each CPU within the set and of each GPU within the set is sliced or divided into a defined number of shares—wherein the defined number of shares equals the identified number of virtual machines or software instances among which the resources of the CPUs and GPUs need to be shared. So for example, if a set comprising 1 CPU and 1 GPU is assigned for implementing 4 virtual machines (or 4 software instances), the processing resources of each of the 1 CPU and the 1 GPU would be divided or sliced into 4 shares—each of the 4 shares (of the 1 CPU and of the 1 GPU respectively) being assigned to one of the 4 virtual machines/software instances. In another example, if a set comprising 1 CPU and 2 GPUs are assigned for implementing 4 virtual machines (or 4 software instances), the processing resources of the 1 CPU and the 2 GPUs would be divided or sliced into 4 shares—each of the 4 shares (of the 1 CPU and of the 2 GPUs) being assigned to one of the 4 virtual machines/software instances. In another example, if a set comprising 2 CPUs and 1 GPU are assigned for implementing 4 virtual machines (or 4 software instances), the processing resources of the 2 CPUs and of the 1 GPU would be divided or sliced into 4 shares—each of the 4 shares (of the 2 CPUs and of the 1 GPUs) being assigned to one of the 4 virtual machines/software instances. As a generalized explanation or example, if a set comprising x CPUs and y GPUs is assigned for implementing n virtual machines (or n software instances), the processing resources of the x CPUs and of the y GPUs would be divided or sliced into n shares—each of the n shares (of the x CPUs and the y GPUs) being assigned to one of the n virtual machines/software instances.

However, even the above approaches fail to capitalize on the fact that CPUs and GPUs inherently have different data processing capabilities and data processing parameters, and also fail to acknowledge or advantageously utilize the fact that the performance of a CPU or a GPU might differ significantly based on the computing task that has been assigned. Additionally, the above approaches fail to recognize the fact that the cost/price for securing a GPU is typically significantly higher than the cost/price for securing a CPU (for example, where the CPU and GPU have been secured/reserved/utilized from within a cloud computing platform)—and as a result, any static virtualization approach where CPUs and GPUs are each divided into an identical number of shares, would result in an undesirably high acquisition cost of computing resources, especially for acquired GPU resources.

The present invention therefore presents a further solution for optimizing virtualization of processing units for implementing cloud computing based services. In this solution, for a set of CPUs and GPUs that are available or that have been secured, obtained or reserved, for implementing an identified number of virtual machines or software instances, the computing resources of the CPUs within that set and the GPUs within that set are asymmetrically shared among the identified number of virtual machines or software instances.

The term “asymmetric” or “” asymmetrically” is used in this context to describe a sharing algorithm where the number of shares that are generated or created for a GPU within the set of CPUs and GPUs is different from the number of shares that are generated or created for a CPU within the set of set of CPUs and GPUs.

As a generalized explanation or example of the above, if a set of x CPUs and y GPUs are assigned for implementing n virtual machines (or n software instances), the processing resources of at least one of (or more than one of, or all of) the x CPUs is divided or sliced into p shares, and the processing resources of at least one of (or more than one of, or all of) the y GPUs is divided or sliced into q shares, where p is not equal to q.

In a specific embodiment of the above, q is greater than p.

In one embodiment of the above, q is equal to n. In another embodiment of the above, one or both of p and q is greater than n. In another embodiment of the above, one or both of p and q is less than n. In yet another embodiment of the above, one of p and q is greater than or equal to n and the other of p and q is less than n. In another embodiment of the above, one of p and q is greater than n and the other of p and q is less than or equal to n.

Each of the p CPU shares is assigned (or is made available for assignment, within a pool of available CPU shares) to a virtual machine or a software instance from among the n virtual machines or n software instances—for execution or implementation of the virtual machine or software instance, or process thread(s) or processing instruction(s) associated with such virtual machine or software instance. Likewise, each of the q GPU shares is assigned (or is made available for assignment, within a pool of available GPU shares) to a virtual machine or a software instance from among the n machines or n software instances—for execution or implementation of the virtual machine or software instance, or process thread(s) or processing instruction(s) associated with such virtual machine or software instance.

By asymmetrically slicing or dividing CPUs and GPUs for the purposes of sharing among a given number of virtual machines or software instances, the invention enables optimized virtualization of processing units for implementing cloud computing based services. The optimization is, among other reasons, a consequence of the fact that the asymmetric slicing or division of CPUs and GPUs enables shares to be generated dynamically and in response to the actual computing demands of the virtual machines/software instances that are under implementation, as opposed to a straightforward static slicing or division. Still further, in embodiments wherein the processing resources of at least one of x CPUs are divided or sliced into p shares, and the processing resources of at least one of the y GPUs is divided or sliced into q shares, where p is not equal to q, and where q is greater than p, the number of GPU shares that the at least one GPU has been sliced or divided into is higher than the number of CPU shares that the at least one CPU has been sliced or divided into—which brings down the average cost of provisioning a virtual machine or software instance with GPU processing resources that it requires, and enables more economical provision of GPU resources to each virtual machine or software instance, despite the overall cost of a GPU being higher than the cost of a CPU.

In an embodiment, the above described solution may be implemented in respect of a set of CPUs and GPUs located within or associated with cloud services platform 304. In another embodiment, the above described solution may be implemented in respect of a set of CPUs and GPUs that are accessed, reserved or secured from a cloud computing platform.

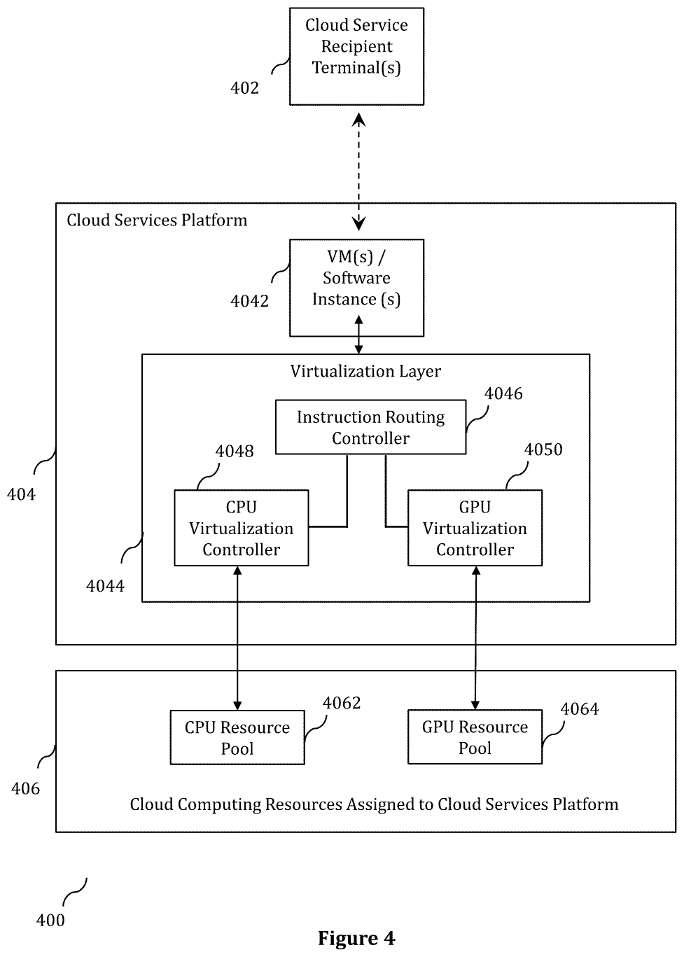

FIG. 4 illustrates a system environment 400 configured to enable optimized virtualization of processing units for implementing cloud computing based services—in accordance with the method described above.

System environment 400 comprises cloud services platform 404 that is communicably coupled with a set of cloud computing resources 406 that have been assigned to cloud services platform 404 for implementing or executing virtual machines or software instances for providing cloud services to one or more cloud service recipient terminal(s) 402. The set of cloud computing resources 406 comprises a CPU resource pool 4062 comprising a set of CPUs assigned to cloud services platform 404, and a GPU resource pool 4064 comprising a set of GPUs assigned to cloud services platform 404. In an embodiment, the CPUs and GPUs within the set of cloud computing resources 406 are CPUs and GPUs within, controlled by or made available by cloud computing platform 306.

As shown in FIG. 4, cloud services platform 404 may instantiate or generate one or more virtual machines or software instances 4042 for the purposes of providing cloud services to one or more cloud service recipient terminal(s) 402.

Cloud services platform additionally includes a processor implemented virtualization layer 4044 which includes a processor implemented instruction routing controller 4046, a processor implemented CPU virtualization controller 4048 and a processor implemented GPU virtualization controller 4050.

Virtualization layer 4044 is configured for implementing virtualization of CPUs and GPUs within CPU resource pool 4062 and GPU resource pool 4064 according to the teachings of the present invention. In a particular embodiment, virtualization layer 4044 is configured so that the CPUs and GPUs that are available within the set of cloud computing resources 406 are asymmetrically shared among an identified number of virtual machines or software instances 4042 that are being implemented or executed by cloud services platform 404.

In more particular embodiments, virtualization layer 4044 is configured such that for a set of x CPUs and y GPUs that are available or assigned for implementing n virtual machines (or n software instances), the processing resources of at least one of (or more than one of, or all of) the x CPUs is divided or sliced into p shares, and the processing resources of at least one of at least one of (or more than one of, or all of) the y GPUs is divided or sliced into q shares, where p is not equal to q.

In a specific embodiment of the above, virtualization layer 4044 is configured such that q is greater than p.

In another embodiment of the above, virtualization layer 4044 is configured such that q is equal to n.

In another embodiment of the above, virtualization layer 4044 is configured such that one or both of p and q is greater than n.

In another embodiment of the above, virtualization layer 4044 is configured such that one or both of p and q is less than n.

In yet another embodiment of the above, virtualization layer 4044 is configured such that one of p and q is greater than or equal to n and the other of p and q is less than n.

In another embodiment of the above, virtualization layer 4044 is configured such that one of p and q is greater than n and the other of p and q is less than or equal to n.

Each of the p CPU shares is assigned (or is made available for assignment, within a pool of available CPU shares) by virtualization layer 4044 to a virtual machine or a software instance 4042 from among the n machines or n software instances—for execution or implementation of the virtual machine or software instance, or process thread(s) or processing instruction(s) associated with such virtual machine or software instance. Likewise, each of the q GPU shares is assigned (or is made available for assignment, within a pool of available GPU shares) by virtualization layer 4044 to a virtual machine or a software instance 4042 from among the n machines or n software instances—for execution or implementation of the virtual machine or software instance, or process thread(s) or processing instruction(s) associated with such virtual machine or software instance.

In an embodiment, CPU virtualization controller 4048 within virtualization layer 4044 implements the generation of slices or shares of the processing resources of CPUs within CPU resource pool 4062, and the assignment of the generated resource slices or resource shares to virtual machines/software instances 4042. Likewise, GPU virtualization controller 4050 within virtualization layer 4044 implements the generation of slices or shares of the processing resources of GPUs within GPU resource pool 4062, and the assignment of the generated resource slices or resource shares to virtual machines/software instances 4042.

For implementing or processing a virtual machine or software instance, software instructions generated by virtual machine/software instance 4042 that are routed to instruction routing controller 4046, which (i) identifies a CPU or a GPU assigned to the virtual machine/software instance 4042 from which the software instruction has been received, (ii) determines whether a received software instruction requires to be executed by a CPU or by a GPU, and (iii) responsive to (a) the received software instruction requiring to be executed by a CPU, routes the software instruction to a CPU (within CPU resource pool 4062) that has been assigned to the virtual machine/software instance 4042 from which the software instruction has been received, or (b) the received software instruction requiring to be executed by a GPU, routes the software instruction to a GPU (within GPU resource pool 4062) that has been assigned to the virtual machine/software instance 4042 from which the software instruction has been received.

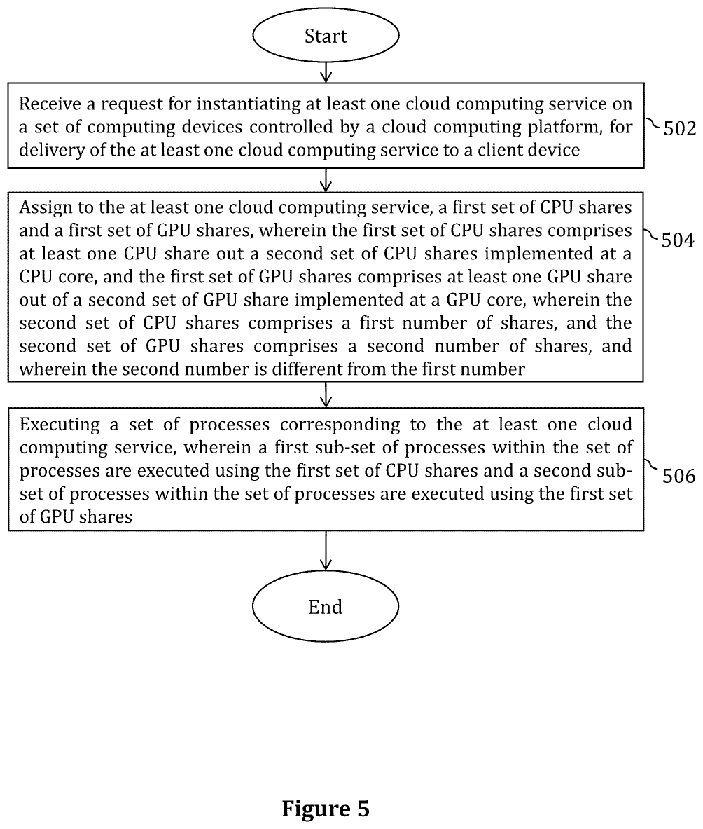

FIG. 5 is a flowchart illustrating a method for optimized virtualization of processing units for implementing cloud computing based services, according to the present invention. In an embodiment the method of FIG. 5 may be implemented at one or more processor implemented computing devices within cloud services platform 304, 404, or within cloud computing platform 306.

Step 502 comprises receiving a request for instantiating at least one cloud computing service on a set of computing devices controlled by a cloud computing platform, for delivery of the at least one cloud computing service to a requesting computing device. In an embodiment, the request (i) may be received from any of a resource user 208, or a client device 302, or a cloud service recipient terminal(s) 402, and/or (ii) may be received at any of cloud computing platform 202, 306, or cloud services platform 304, 404. In an embodiment, instantiating the at least one cloud computing service comprises instantiating at least one virtual machine or at least one instance of a software application on a set of computing devices controlled by the cloud computing platform (for example on a plurality of nodes 2062, 2064, 2066 or computing components within said plurality of nodes 2062, 2064, 2066)—whereinafter inputs from the resource user 208/client device 302/cloud service recipient terminal(s) 402 are transmitted to the instantiated virtual machine or to the instantiated instance of the software application as inputs to said virtual machine or said instance of the software application, and output from the instantiated virtual machine or the instantiated instance of the software application is transmitted to the resource user 208/client device 302/cloud service recipient terminal(s) 402—for processing by, or for display or presentation at said resource user 208/client device 302/cloud service recipient terminal(s) 402.

Step 504 comprises assigning to the at least one cloud computing service (i.e. for the purpose of implementing the at least one cloud computing service, or for execution one or more processes associated with the at least one cloud computing service), a first set of CPU shares and a first set of GPU shares. The first set of CPU shares comprises at least one CPU share from among a second set of CPU shares implemented at a CPU core, and the first set of GPU shares comprises at least one GPU share from among a second set of GPU shares implemented at a GPU core. In an embodiment (i) the second set of CPU shares comprises the entire set of CPU shares implemented at the CPU core at the time of instantiation of the at least one cloud computing service, or at the time when the first set of CPU shares are assigned at step 504, and (ii) the second set of GPU shares comprises the entire set of GPU shares implemented at the GPU core at the time of instantiating the at least one cloud computing service, or at the time the first set of GPU shares are assigned at step 504. In an embodiment, the number of CPU shares within the second set of CPU shares is different from the number of GPU shares within the second set of GPU shares. In a more particular embodiment, the number of GPU shares within the second set of GPU shares is greater than the number of CPU shares within the second set of CPU shares. Stated differently, in this embodiment, a larger number of GPU shares have been implemented at the GPU core in comparison with the number of CPU shares that have been implemented at the CPU core.

In an exemplary embodiment of the method (i) the first set of CPU shares assigned to the at least one cloud computing service (at step 504), comprises at least one CPU share from among a second set of CPU shares implemented at a CPU core (i.e. a second set of CPU shares that have been implemented at the CPU core at the time of instantiation of the at least one cloud computing service, or at the time when the first set of CPU shares are assigned at step 504)—wherein the second set of CPU shares comprises or consists of p CPU shares, and (ii) the first set of GPU shares assigned to the at least one cloud computing service (at step 504), comprises at least one GPU share from among a second set of GPU shares implemented at a GPU core (i.e. a second set of GPU shares that have been implemented at the GPU core at the time of instantiation of the at least one cloud computing service, or at the time when the first set of GPU shares are assigned at step 504)—wherein the second set of GPU shares comprises or consists of a total of q CPU shares. In a specific embodiment, p is not equal to q—i.e. the number of CPU shares within the second set of CPU shares implemented at the CPU core is not equal to the number of GPU shares within the second set of GPU shares implemented at the GPU core. In a more particular embodiment, q is greater than p—i.e. the number of GPU shares within the second set of GPU shares implemented at the GPU core is greater than the number of CPU shares within the second set of CPU shares implemented at the CPU core.

In an even more specific embodiment of the above, instantiating or implementing the at least one cloud computing service at step 502 comprises instantiating n virtual machines or n instances of a software application, and
the second set of GPU shares comprises a total of q GPU shares, such that q is equal to n, or
the second set of CPU shares comprises a total of p CPU shares, the second set of GPU shares comprises a total of q GPU shares, and one or both of p and q is less than n, or.
the second set of CPU shares comprises a total of p CPU shares, the second set of GPU shares comprises a total of q GPU shares, and one of p and q is greater than or equal to n and the other of p and q is less than n, or.
the second set of CPU shares comprises a total of p CPU shares, the second set of GPU shares comprises a total of q GPU shares, one of p and q is greater than n, and the other of p and q is less than or equal to n.

In an even more particular embodiment of the method, each of the p CPU shares is assigned (or is made available for assignment, within a pool of available CPU shares) to a virtual machine or a software instance from among n virtual machines or n software instances (that the cloud service is comprised of)—for execution or implementation of the virtual machine or software instance, or process thread(s) or processing instruction(s) associated with such virtual machine or software instance. Likewise, each of the q GPU shares is assigned (or is made available for assignment, within a pool of available GPU shares) to a virtual machine or a software instance from among n virtual machines or n software instances (that the cloud service is comprised of)—for execution or implementation of the virtual machine or software instance, or process thread(s) or processing instruction(s) associated with such virtual machine or software instance.

Step 506 comprises executing a set of processes corresponding to the at least one cloud computing service, wherein a first sub-set of processes within the set of processes are executed by the first set of CPU shares, and a second sub-set of processes within the set of processes are executed by the first set of GPU shares.

In an embodiment, subsequent to step 506, inputs from the resource user 208/client device 302/cloud service recipient terminal(s) 402 are provided as input to one or more processes within the set of processes. In a further embodiment, subsequent to step 506, outputs from one or more processes within the set of processes are transmitted or streamed to the client device resource user 208/client device 302/cloud service recipient terminal(s) 402—for processing, display or presentation at resource user 208/client device 302/cloud service recipient terminal(s) 402.

For the purposes of this invention, it will be understood that CPU shares and/or GPU shares within a respective CPU or GPU can be implemented or generated in any number of ways that would be apparent to the skilled person, including without limitation: by dividing or sharing the respective CPU or GPU resources based on defined resource division algorithms or formulas, or by timeslicing.

The invention provides a method for optimized virtualization of processing units for implementing one or more cloud computing services. In an embodiment, the method comprises implementing at a processor, the steps of (i) receiving a request for instantiating at least one cloud computing service, (ii) assigning for execution of the at least one cloud computing service (a) a first set of central processing unit (CPU) shares, and (b) a first set of graphic processing unit (GPU) shares, and (iii) executing a set of processes corresponding to the at least one cloud computing service, wherein (c) a first sub-set of processes within the set of processes are executed by the first set of CPU shares, and (d) a second sub-set of processes within the set of processes are executed by the first set of GPU shares.

In an embodiment of the method (i) the first set of CPU shares comprises at least one CPU share from among a second set of CPU shares implemented at a CPU core, (ii) the first set of GPU shares comprises at least on GPU share from among a second set of GPU shares implemented at a GPU core, and (iii) a first number of CPU shares within the second set of CPU shares is different from a second number of GPU shares within the second set of GPU shares.

In a more specific embodiment of the method, the second number of GPU shares is greater than the first number of CPU shares.

In another method embodiment (i) implementing the at least one cloud computing service comprises instantiating a third number of virtual machines or a third number of instances of a software application, and (ii) the second number of GPU shares is equal to the third number of virtual machines or to the third number of instances of the software application.

In a method embodiment (i) implementing the at least one cloud computing service comprises instantiating a third number of virtual machines or a third number of instances of a software application, and (ii) one or both of the first number of CPU shares and the second number of GPU shares is less than the third number of virtual machines or the third number of instances of the software application.

In another method embodiment, (i) implementing the at least one cloud computing service comprises instantiating a third number of virtual machines or a third number of instances of a software application, (ii) one of the first number of CPU shares and the second number of GPU shares is greater than or equal to the third number of virtual machines or the third number of instances of the software application, and (iii) the other of the first number of CPU shares and the second number of GPU shares is less than the third number of virtual machines or the third number of instances of the software application.

In an alternate method embodiment, (i) implementing the at least one cloud computing service comprises instantiating a third number of virtual machines or a third number of instances of a software application, (ii) one of the first number of CPU shares and the second number of GPU shares is greater than the third number of virtual machines or the third number of instances of the software application, and (iii) the other of the first number of CPU shares and the second number of GPU shares is less than or equal to the third number of virtual machines or the third number of instances of the software application.

In yet another embodiment of the method, instantiating the at least one cloud computing service comprises instantiating at least one virtual machine or at least one instance of a software application in a set of computing devices controlled by a cloud computing platform.

The invention also provides a system for optimized virtualization of processing units for implementing one or more cloud computing services. In an embodiment, the system comprises at least one memory, and a processor. The processor is configured to perform the steps of (i) receiving a request for instantiating at least one cloud computing service, (ii) assigning for execution of the at least one cloud computing service (a) a first set of central processing unit (CPU) shares, and (b) a first set of graphic processing unit (GPU) shares, and (iii) executing a set of processes corresponding to the at least one cloud computing service, wherein (c) a first sub-set of processes within the set of processes are executed by the first set of CPU shares, and (d) a second sub-set of processes within the set of processes are executed by the first set of GPU shares.

In an embodiment of the system (i) the first set of CPU shares comprises at least one CPU share from among a second set of CPU shares implemented at a CPU core, (ii) the first set of GPU shares comprises at least on GPU share from among a second set of GPU shares implemented at a GPU core, and (iii) a first number of CPU shares within the second set of CPU shares is different from a second number of GPU shares within the second set of GPU shares.

In a more specific embodiment of the system, the second number of GPU shares is greater than the first number of CPU shares.

In another system embodiment (i) implementing the at least one cloud computing service comprises instantiating a third number of virtual machines or a third number of instances of a software application, and (ii) the second number of GPU shares is equal to the third number of virtual machines or to the third number of instances of the software application.

In a system embodiment (i) implementing the at least one cloud computing service comprises instantiating a third number of virtual machines or a third number of instances of a software application, and (ii) one or both of the first number of CPU shares and the second number of GPU shares is less than the third number of virtual machines or the third number of instances of the software application.

In another system embodiment, (i) implementing the at least one cloud computing service comprises instantiating a third number of virtual machines or a third number of instances of a software application, (ii) one of the first number of CPU shares and the second number of GPU shares is greater than or equal to the third number of virtual machines or the third number of instances of the software application, and (iii) the other of the first number of CPU shares and the second number of GPU shares is less than the third number of virtual machines or the third number of instances of the software application.

In an alternate system embodiment, (i) implementing the at least one cloud computing service comprises instantiating a third number of virtual machines or a third number of instances of a software application, (ii) one of the first number of CPU shares and the second number of GPU shares is greater than the third number of virtual machines or the third number of instances of the software application, and (iii) the other of the first number of CPU shares and the second number of GPU shares is less than or equal to the third number of virtual machines or the third number of instances of the software application.

In yet another system embodiment, instantiating the at least one cloud computing service comprises instantiating at least one virtual machine or at least one instance of a software application in a set of computing devices controlled by a cloud computing platform.

The invention also provides a computer program product for optimized virtualization of processing units for implementing one or more cloud computing services. In an embodiment, the computer program product comprises a non-transitory computer readable medium having a computer readable program code embodied therein, the computer readable program code comprising instructions for implementing the steps of (i) receiving a request for instantiating at least one cloud computing service, (ii) assigning for execution of the at least one cloud computing service (a) a first set of central processing unit (CPU) shares, and (b) a first set of graphic processing unit (GPU) shares, and (iii) executing a set of processes corresponding to the at least one cloud computing service, wherein (c) a first sub-set of processes within the set of processes are executed by the first set of CPU shares, and (d) a second sub-set of processes within the set of processes are executed by the first set of GPU shares.

In an embodiment of the computer program product (i) the first set of CPU shares comprises at least one CPU share from among a second set of CPU shares implemented at a CPU core, (ii) the first set of GPU shares comprises at least on GPU share from among a second set of GPU shares implemented at a GPU core, and (iii) a first number of CPU shares within the second set of CPU shares is different from a second number of GPU shares within the second set of GPU shares.

In a more specific embodiment of the computer program product, the second number of GPU shares is greater than the first number of CPU shares.

In another computer program product embodiment (i) implementing the at least one cloud computing service comprises instantiating a third number of virtual machines or a third number of instances of a software application, and (ii) the second number of GPU shares is equal to the third number of virtual machines or to the third number of instances of the software application.

In a computer program product embodiment (i) implementing the at least one cloud computing service comprises instantiating a third number of virtual machines or a third number of instances of a software application, and (ii) one or both of the first number of CPU shares and the second number of GPU shares is less than the third number of virtual machines or the third number of instances of the software application.

In another computer program product embodiment, (i) implementing the at least one cloud computing service comprises instantiating a third number of virtual machines or a third number of instances of a software application, (ii) one of the first number of CPU shares and the second number of GPU shares is greater than or equal to the third number of virtual machines or the third number of instances of the software application, and (iii) the other of the first number of CPU shares and the second number of GPU shares is less than the third number of virtual machines or the third number of instances of the software application.

In an alternate computer program product embodiment, (i) implementing the at least one cloud computing service comprises instantiating a third number of virtual machines or a third number of instances of a software application, (ii) one of the first number of CPU shares and the second number of GPU shares is greater than the third number of virtual machines or the third number of instances of the software application, and (iii) the other of the first number of CPU shares and the second number of GPU shares is less than or equal to the third number of virtual machines or the third number of instances of the software application.

In yet another embodiment of the computer program product, instantiating the at least one cloud computing service comprises instantiating at least one virtual machine or at least one instance of a software application in a set of computing devices controlled by a cloud computing platform.

It will be understood that as a consequence of implementing the method of FIG. 5, CPU and GPU resources are allocated to a cloud service for implementing or execution the cloud service (or for implementing or executing processes associated with the cloud service) in any asymmetric manner—i.e. where the number of shares that are generated or created for a GPU core that is being used to implement or execute cloud service processes is different from, and in a preferred embodiment, is greater than number of shares that are generated or created for a CPU core that is being used to implement or execute cloud service processes. This results in overall improvements in cost and processing resource consumption efficiencies, when compared to previously known solutions.

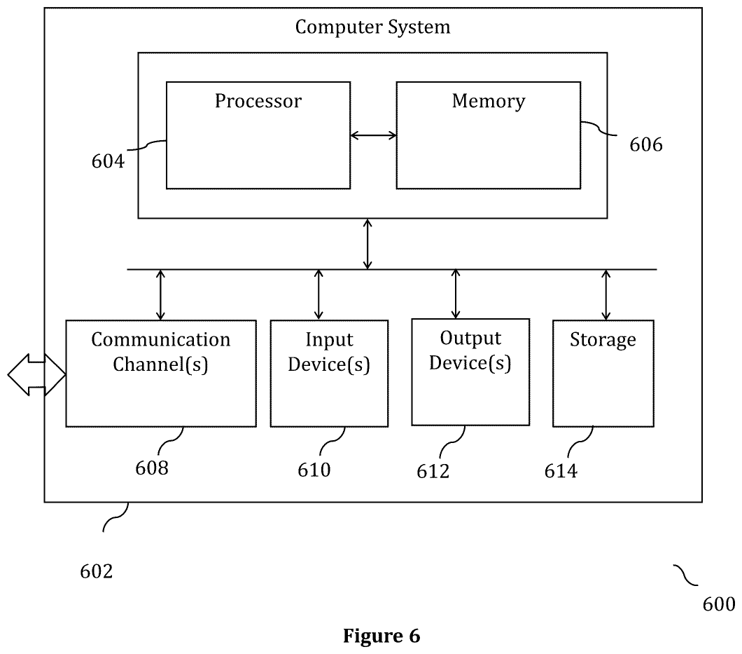

FIG. 6 illustrates an exemplary system 600 for implementing the present invention. The illustrated system 600 comprises computer system 602 which in turn comprises one or more processors 604 and at least one memory 606. Processor 604 is configured to execute program instructions—and may be a real processor or a virtual processor. It will be understood that computer system 602 does not suggest any limitation as to scope of use or functionality of described embodiments. The computer system 602 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 602 in accordance with the present invention may include one or more servers, desktops, laptops, tablets, smart phones, mobile phones, mobile communication devices, tablets, phablets and personal digital assistants. In an embodiment of the present invention, the memory 606 may store software for implementing various embodiments of the present invention. The computer system 602 may have additional components. For example, the computer system 602 may include one or more communication channels 608, one or more input devices 610, one or more output devices 612, and storage 614. An interconnection mechanism (not shown) such as a bus, controller, or network, interconnects the components of the computer system 602. In various embodiments of the present invention, operating system software (not shown) provides an operating environment for various softwares executing in the computer system 602 using a processor 604, and manages different functionalities of the components of the computer system 602.

The communication channel(s) 608 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 610 may include, but is not limited to, a touch screen, a keyboard, mouse, pen, joystick, trackball, a voice device, a scanning device, or any another device that is capable of providing input to the computer system 602. In an embodiment of the present invention, the input device(s) 610 may be a sound card or similar device that accepts audio input in analog or digital form. The output device(s) 612 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 602.

The storage 614 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 602. In various embodiments of the present invention, the storage 614 may contain program instructions for implementing any of the described embodiments.

In an embodiment of the present invention, the computer system 602 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 602. The method described herein is typically implemented as a computer program product, comprising a set of program instructions that is executed by the computer system 602 or any other similar device. The set of program instructions may be a series of computer readable codes stored on a tangible medium, such as a computer readable storage medium (storage 614), for example, diskette, CD-ROM, ROM, flash drives or hard disk, or transmittable to the computer system 602, via a modem or other interface device, over either a tangible medium, including but not limited to optical or analogue communications channel(s) 608. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

The invention accordingly provides solutions for optimized virtualization of processing units for implementing cloud computing based services. As a consequence of implementing the teachings of the present invention, CPU and GPU resources can be allocated to a cloud service for implementing or execution the cloud service (or processes associated with the cloud service) asymmetrically—wherein processes associated with the cloud service are executed using at least one CPU core and at least one GPU core, and wherein the number of shares that are generated or created for a GPU core that is being used to implement or execute said cloud service processes is different from, and in a preferred embodiment is greater than, the number of shares that are generated or created for a CPU core that is being used to implement or execute said cloud service processes—which results in overall improvements in cost and processing resource consumption efficiencies, when compared to previously known solutions.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment specifically contemplated, is intended to be practiced in the absence of any element which is not specifically disclosed herein.

We claim:

1. A method for optimized virtualization of processing units for implementing one or more cloud computing services, comprising implementing at a processor, the steps of:
receiving a request for instantiating at least one cloud computing service;
assigning for execution of the at least one cloud computing service:
a first set of central processing unit (CPU) shares; and
a first set of graphic processing unit (GPU) shares;
and executing a set of processes corresponding to the at least one cloud computing service, wherein:
a first sub-set of processes within the set of processes are executed by the first set of CPU shares; and
a second sub-set of processes within the set of processes are executed by the first set of GPU shares;
wherein:
the first set of CPU shares comprises at least one CPU share from among a second set of CPU shares implemented at a CPU core;
the first set of GPU shares comprises at least on GPU share from among a second set of GPU shares implemented at a GPU core; and
a first number of CPU shares within the second set of CPU shares is different from a second number of GPU shares within the second set of GPU shares.

2. The method as claimed in claim 1, wherein the second number of GPU shares is greater than the first number of CPU shares.

3. The method as claimed in claim 1, wherein:
implementing the at least one cloud computing service comprises instantiating a third number of virtual machines or a third number of instances of a software application;
and
the second number of GPU shares is equal to the third number of virtual machines or to the third number of instances of the software application.

4. The method as claimed in claim 1, wherein:
implementing the at least one cloud computing service comprises instantiating a third number of virtual machines or a third number of instances of a software application;
and
one or both of the first number of CPU shares and the second number of GPU shares is less than the third number of virtual machines or the third number of instances of the software application.

5. The method as claimed in claim 1, wherein:
implementing the at least one cloud computing service comprises instantiating a third number of virtual machines or a third number of instances of a software application;
one of the first number of CPU shares and the second number of GPU shares is greater than or equal to the third number of virtual machines or the third number of instances of the software application; and
the other of the first number of CPU shares and the second number of GPU shares is less than the third number of virtual machines or the third number of instances of the software application.

6. The method as claimed in claim 1, wherein:
implementing the at least one cloud computing service comprises instantiating a third number of virtual machines or a third number of instances of a software application;
one of the first number of CPU shares and the second number of GPU shares is greater than the third number of virtual machines or the third number of instances of the software application; and
the other of the first number of CPU shares and the second number of GPU shares is less than or equal to the third number of virtual machines or the third number of instances of the software application.

7. The method as claimed in claim 1, wherein instantiating the at least one cloud computing service comprises instantiating at least one virtual machine or at least one instance of a software application in a set of computing devices controlled by a cloud computing platform.

8. A system for optimized virtualization of processing units for implementing one or more cloud computing services, the system comprising:
at least one memory; and
a processor configured to perform the steps of:
receiving a request for instantiating at least one cloud computing service;
assigning for execution of the at least one cloud computing service:
a first set of central processing unit (CPU) shares; and
a first set of graphic processing unit (GPU) shares;
and executing a set of processes corresponding to the at least one cloud computing service, wherein:
a first sub-set of processes within the set of processes are executed by the first set of CPU shares; and
a second sub-set of processes within the set of processes are executed by the first set of GPU shares;
wherein:
the first set of CPU shares comprises at least one CPU share from among a second set of CPU shares implemented at a CPU core;
the first set of GPU shares comprises at least on GPU share from among a second set of GPU shares implemented at a GPU core; and
a first number of CPU shares within the second set of CPU shares is different from a second number of GPU shares within the second set of GPU shares.

9. The system as claimed in claim 8, wherein the second number of GPU shares is greater than the first number of CPU shares.

10. The system as claimed in claim 8, wherein:
implementing the at least one cloud computing service comprises instantiating a third number of virtual machines or a third number of instances of a software application;
and
the second number of GPU shares is equal to the third number of virtual machines or to the third number of instances of the software application.

11. The system as claimed in claim 8, wherein:
implementing the at least one cloud computing service comprises instantiating a third number of virtual machines or a third number of instances of a software application;
and
one or both of the first number of CPU shares and the second number of GPU shares is less than the third number of virtual machines or the third number of instances of the software application.

12. The system as claimed in claim 8, wherein:
implementing the at least one cloud computing service comprises instantiating a third number of virtual machines or a third number of instances of a software application;
one of the first number of CPU shares and the second number of GPU shares is greater than or equal to the third number of virtual machines or the third number of instances of the software application; and
the other of the first number of CPU shares and the second number of GPU shares is less than the third number of virtual machines or the third number of instances of the software application.

13. The system as claimed in claim 8, wherein:
implementing the at least one cloud computing service comprises instantiating a third number of virtual machines or a third number of instances of a software application;
one of the first number of CPU shares and the second number of GPU shares is greater than the third number of virtual machines or the third number of instances of the software application; and
the other of the first number of CPU shares and the second number of GPU shares is less than or equal to the third number of virtual machines or the third number of instances of the software application.

14. The system as claimed in claim 8, wherein instantiating the at least one cloud computing service comprises instantiating at least one virtual machine or at least one instance of a software application in a set of computing devices controlled by a cloud computing platform.

15. A computer program product for optimized virtualization of processing units for implementing one or more cloud computing services, the computer program product comprising a non-transitory computer readable medium having a computer readable program code embodied therein, the computer readable program code comprising instructions for implementing the steps of:
receiving a request for instantiating at least one cloud computing service;
assigning for execution of the at least one cloud computing service:
a first set of central processing unit (CPU) shares; and
a first set of graphic processing unit (GPU) shares;
and executing a set of processes corresponding to the at least one cloud computing service, wherein:
a first sub-set of processes within the set of processes are executed by the first set of CPU shares; and
a second sub-set of processes within the set of processes are executed by the first set of GPU shares;
wherein:
the first set of CPU shares comprises at least one CPU share from among a second set of CPU shares implemented at a CPU core;
the first set of GPU shares comprises at least on GPU share from among a second set of GPU shares implemented at a GPU core; and
a first number of CPU shares within the second set of CPU shares is different from a second number of GPU shares within the second set of GPU shares.
